(19) United States
(12) Patent Application Publication
(10) Pub. No.: US 2016/0078514 A1
(43) Pub. Date: Mar. 17, 2016

(54) TRADE MATCHING SYSTEM OF CONSUMER AND SUPPLIER AND METHOD THEREOF

(71) Applicants: Donghwi KIM, Seoul (KR); Kyungmin JI, Ulsan (KR)

(72) Inventors: Donghwi KIM, Seoul (KR); Kyungmin JI, Ulsan (KR)

(21) Appl. No.: 14/531,228

(22) Filed: Nov. 3, 2014

(30) Foreign Application Priority Data
Sep. 11, 2014 (KR) 10-2014-0120437

(51) Int. Cl. G06Q 30/06; G06Q 20/10

(52) U.S. Cl. CPC G06Q 30/0617; G06Q 20/10

(57) ABSTRACT

A trade matching system of consumer and supplier includes a user terminal which transfers the product information the consumer has to the server, and executes the transaction procedure using the information retrieved from the server, a site server which displays the product information sent from the consumer on the display unit, transmits the supplier's product information if it is a match to the consumer's requests, and processes the transactions, delivering the results to both user and supplier terminal if the consumer decides to purchase the product, and a supplier terminal which provides the specifications, the price, the delivery options, and other information of the identical or similar product the consumer decides to purchase, and receives the result of the transaction.

### BACKGROUND OF THE INVENTION

1. Field of the Invention

This invention is associated with the pairing of consumers and suppliers. Normally, the consumers use websites like Naver (or google) to find information for the products that they want to purchase. But if they are searching for unique products with special features or goods that are produced only in a foreign country, it will be difficult for them to find suppliers who can meet their demand. For situations like these, this invention allows the consumers to just enter the name, usage, and other characteristics of the product on a certain website, which will then be directly sent to the suppliers for them to provide the product details to the consumers.

2. Description of the Related Art

This invention is associated with the Korean Publication No. 10-2014-0016426 (publicly available on 2014 Feb. 7). FIG. 1 shows a control flowchart illustrating the methods to facilitate trade by image-matching, compared to the existing content-delivery system. To promote transaction through image-matching under the existing content-delivery system, the contents are broadcast using the mobile TV broadcast network (100) or internet multicaster (402), which will then be received and displayed by the computing devices programmed to accept such contents (404). Next, the consumers will be able to select certain sections of the product image and display the product query (406). For example, if the computing device is a smart phone, the consumers will be able to touch the selected product image and display the product specifications. The computing device may also be programmed to register the input data and create the product query message containing the information of the image selected, by using the unicast network and sending it to the transaction server (112) (408). Next, the transaction server (112) will receive the product query message, process the image selected, and identify the objects within the selected picture (410). As it will be explained eventually, various image recognition technologies can be implemented to identify certain image objects. Afterwards, the identified image objects will be compared to the product images stored within the inventory database (412) and be analyzed for a match (decision 414). If the answer is affirmative (decision 414=“yes”), the product's brand name, source, price and other information can be sent to the mobile device (416). Also, recommender system (308) can be used to increase the number of matches that suits the consumer's needs. If the image objects do not correspond to the products within the database (decision 414=“no”), image object can be used with other information from the recommender system to suggest an alternative product (418). The whole process includes sending such recommendations to the mobile device (420) as a feature.

### SUMMARY OF THE INVENTION

When sending the requested information that matches with the product data stored in the server, it has possibility of causing the server overload, which, in turn, is a cause of concern under the current technology. In addition, the suppliers cannot provide diverse information real-time. This invention, however, aids consumers in receiving necessary information and selecting the product without causing the above complications. Another purpose of this invention is to match consumers and suppliers through the searcher and stimulate transactions between them.

This matching system comprises the following:

The user terminal, which transfers the product information the consumer has to the server, executes the transaction procedure using the information retrieved from the server, and receives the result of the transaction,

The site server, which displays the product information sent from the consumer on the display unit, transmits the supplier's product information if it is a match to the consumer's requests, and processes the transactions, delivering the results to both user and supplier terminal if the consumer decides to purchase the product,

The supplier terminal, which accesses the site server and retrieve information about the product in demand by the consumer, provides the specifications, the price, the delivery options, and other information of the identical or similar product the consumer decides to purchase, and receives the result of the transaction.

The steps to execute the Trade matching system of consumer and supplier are as follows:

1. The consumer sends the image, name, and other information about the product that they want to purchase.

2. The site server displays the product information on the display unit.

3. The supplier logs into the site server using the supplier terminal and receives the product information.

4. Comparison of the data of the product in demand and the data of the product stored in the supplier terminal.

5. If products are either identical or similar, the supplier's product information is sent to the site server.

6. The site server transfers the supplier's product information to the user terminal.

7. The consumer purchases the product using the user terminal by accessing the site server and going through the necessary purchasing process.

8. The site server transmits the transaction results to the user and supplier terminal afterwards.

### BRIEF DESCRIPTION OF THE DRAWINGS

FIG. 1 is a control flow diagram to facilitate transaction through image-matching under a conventional content-delivery system.

FIG. 2 is a first embodiment of the trade matching system of consumer and supplier.

FIG. 3 is a second embodiment of the trade matching system of consumer and supplier.

FIG. 4 is a first embodiment of the control flow diagram of the trade matching method of consumer and supplier.

FIG. 5 is a second embodiment of the control flow diagram of the trade matching method of consumer and supplier.

FIG. 6 is a third embodiment of the control flow diagram of the trade matching method of consumer and supplier

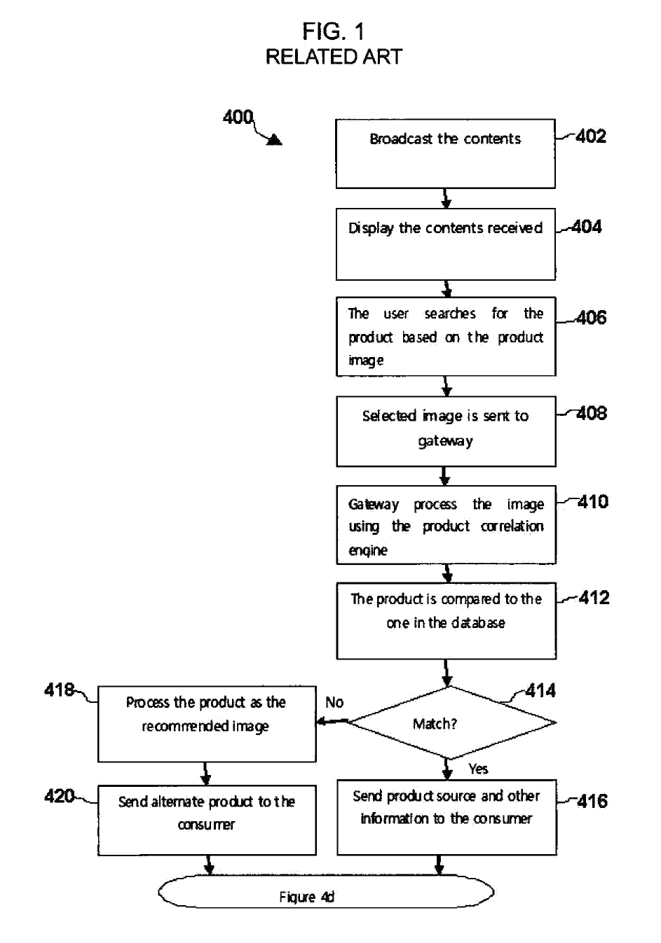

### DETAILED DESCRIPTION OF THE EMBODIMENTS

The characteristics of this invention and its consumer-supplier matching method are as follows.

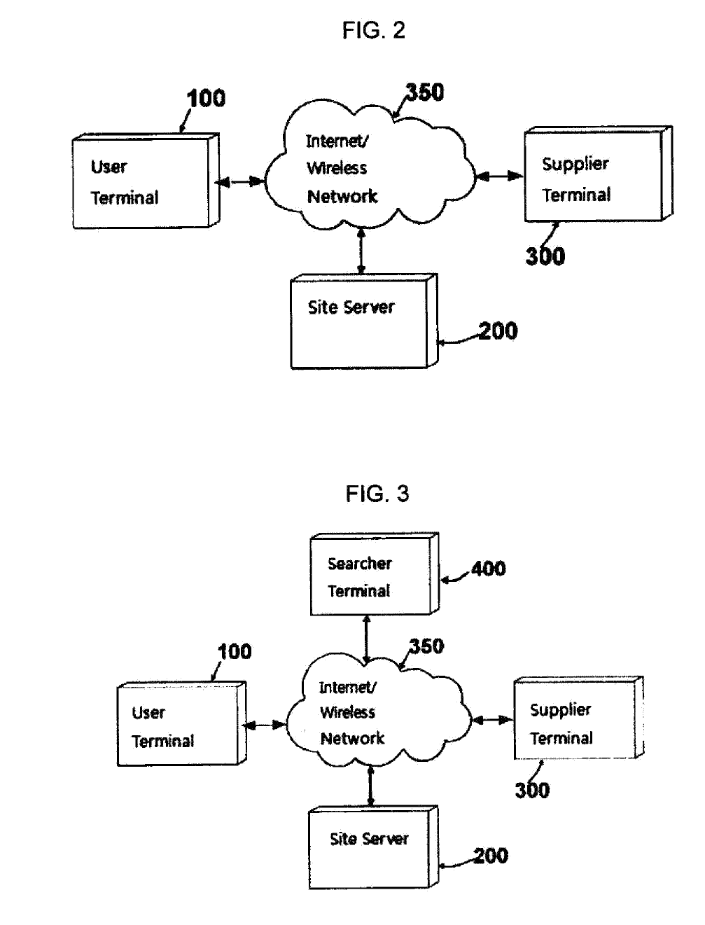

FIG. 2 is the first embodiment of the trade matching system of consumer and supplier. It is comprised of

1. The user terminal (100): It transfers the product information, such as the name and image etc., the consumer has to the server, executes the transaction procedure using the information retrieved from the server, and receives the result of the transaction.

2. The site server (200): It displays the product information sent from the consumer on the display unit, sends information based on the consumer's requests, determines if the products are a match, and processes the transactions, delivering the results to both user and supplier terminal if the consumer decides to purchase the product.

3. The supplier terminal (300): It accesses the site server and retrieve information about the product purchased by the consumer, provides the specifications, the price, the delivery options, and other information of the identical or similar product the consumer is likely to purchase, and receives the result of the transaction.

4. The internet or wireless network (350): It connects the user terminal, the site server, and the supplier terminal.

The financial transactions will be carried out using the credit card, or through internet banking, account transfer, et cetera, based on the specification, price, delivery options, and other product information provided.

FIG. 3 is a second embodiment of the trade matching system of consumer and supplier. It is comprised of

1. The user terminal (100): It transfers the name, image, and the characteristics of the product to the site server, performs transaction process and receives the transaction results based on the supplier's product information received from the site server.

2. The site searcher terminal (400): It registers on the site server, receives the information about the product requested by the consumer from the site server, transfers the supplier and product details searched from the supplier's website to the site server when the product search results are identical or similar to the demands of the consumer, and receives the result of the transaction if the product is actually purchased.

3. The site server (200): It receives and saves the supplier, product and purchasing information received from the searcher terminal, sends the above information to the user terminal to aid the consumer's purchasing decision, processes the transaction based on the supplier, product, and purchasing information provided, and sends the results to each of the user, searcher, and supplier terminal.

4. The supplier terminal (300): It transmits the supplier, product and purchasing information to the searcher terminal if requested, and receives the results of the transaction if purchasing process is complete.

5. The internet or the wireless network (350): It connects the user terminal, the site server, the searcher terminal, and the supplier terminal.

The financial transactions will be carried out using the credit card, or through internet banking, account transfer, et cetera, based on the specification, price, delivery options, and other product information provided.

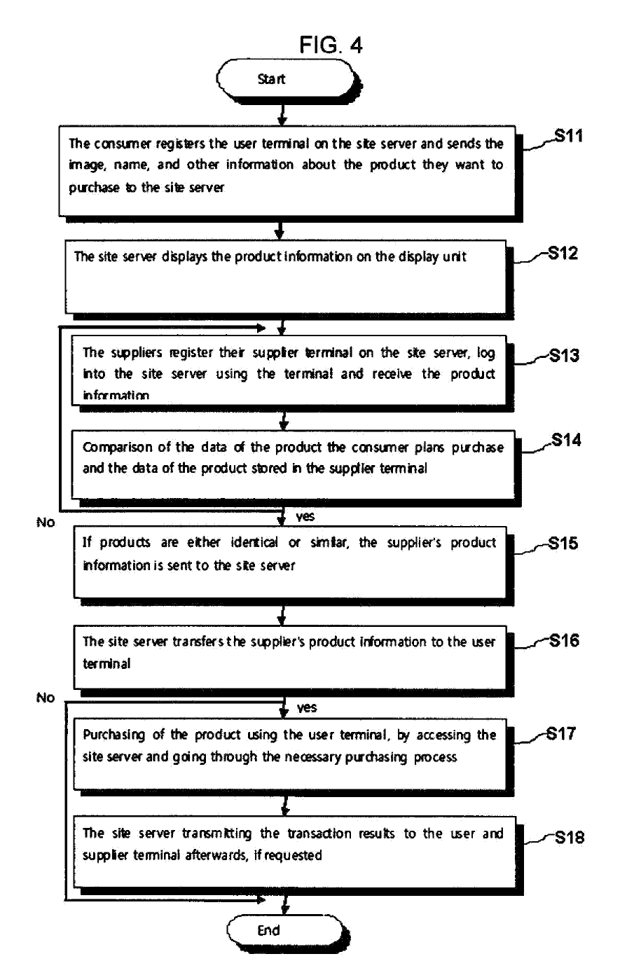

FIG. 4 is the first embodiment of the control flow diagram of the trade matching method of consumer and supplier. It is carried out in following stages:

1. The consumer registers the user terminal on the site server and sends the image, name, and other information about the product they want to purchase to the site server (S11).

2. The site server displays the product information on the display unit (S12).

3. The suppliers register their supplier terminal on the site server, log into the site server using the terminal and receive the product information (S13).

4. Comparison of the data of the product the consumer plans to purchase and the data of the product stored in the supplier terminal (S14).

5. If products are either identical or similar, the supplier's product information is sent to the site server (S15).

6. The site server transfers the supplier's product information to the user terminal (S16).

7. Purchasing of the product, using the user terminal by accessing the site server and going through the necessary purchasing process (S17).

8. The site server transmits the transaction results to the user and supplier terminal afterwards if requested (S18).

The supplier information can contain both the name of the company and its CEO, and the purchase information, the price of the product, purchase history, discount information, delivery options, et cetera. In addition, the transaction results can contain information about the customer, supplier, amount purchased, price, actual amount paid, date, et cetera. However, if matching product cannot be found on S14 stage, it will be able to suggest different product, or end the process, or allow another supplier to participate from stage S13.

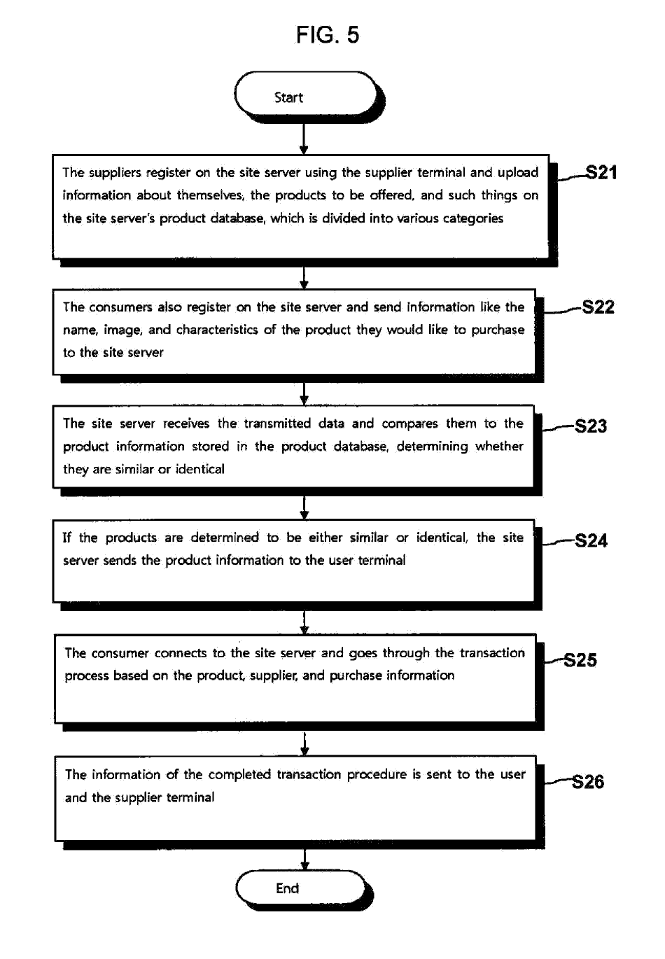

FIG. 5 is the second embodiment of the control flow diagram of the trade matching method of consumer and supplier. It is carried out in following stages:

1. The suppliers register on the site server using the supplier terminal and upload information about themselves, the products to be offered, and such things on the site server's product database, which is divided into various categories (S21).

2. The consumers also register their user terminal on the site server and send information like the name, image, and characteristics of the product they would like to purchase to the site server (S22).

3. The site server receives the transmitted data and compares them to the product information stored in the product database, determining whether they are similar or identical (S23).

4. If the products are determined to be either similar or identical, the site server sends the product information to the user terminal (S24).

5. The consumer connects to the site server and goes through the transaction process based on the product, supplier, and purchase information provided (S25).

6. The information of the completed transaction procedure is sent to the user and the supplier terminal (S26).

Determining whether the data sent from the consumer is similar or identical to the information registered on the site server product database can be done by comparing the name, image information, product specifications, et cetera.

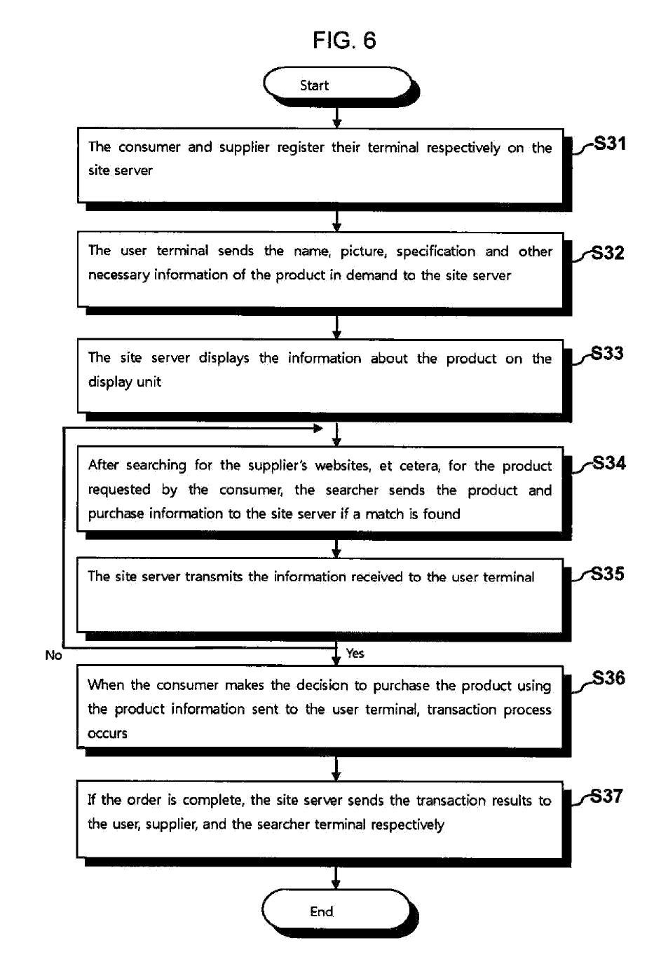

FIG. 6 is the third embodiment of the control flow diagram of the trade matching method of consumer and supplier. It is carried out in following stages:

1. The consumer and supplier register their terminal respectively on the site server (S31).

2. The user terminal sends the name, picture, specification and other necessary information of the product in demand to the site server (S32).

3. The site server displays the information about the product on the display unit (S33).

4. After searching the supplier's websites, et cetera, for the product requested by the consumer, the searcher sends the product and purchase information to the site server if a match is found (S34).

5. The site server transmits the information received to the user terminal (S35).

6. When the consumer makes the decision to purchase the product using the product information sent to the user terminal, transaction process occurs (S36).

7. If the order is complete, the site server sends the transaction results to the user, supplier, and the searcher terminal respectively (S37).

Information about the supplier's product, price and delivery information will be sent during the transaction process, and the payment process will be carried out using the credit card, or through internet banking, account transfer, et cetera.

According to the embodiments of the present invention, it can increase the online trade volume by providing virtual marketplace. Also, large numbers of suppliers can provide information about identical or similar products, which will in turn aid consumers in selecting the best product. Being able to purchase without limitation of time and space is another basic advantage.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A trade matching system of consumer and supplier, comprising:
a user terminal (100), which transfers the product information the consumer has to the server, executes the transaction procedure using the information retrieved from the server, and receives the result of the transaction;
a site server (200), which displays the product information sent from the consumer on the display unit, transmits the supplier's product information if it is a match to the consumer's requests, and processes the transactions, delivering the results to both user and supplier terminal if the consumer decides to purchase the product;
a supplier terminal (300), which accesses the site server and retrieve information about the product in demand by the consumer, provides the specifications, the price, the delivery options, and other information of the identical or similar product the consumer is likely to purchase, and receives the result of the transaction; and
an Internet or a wireless network (350), which connects the user terminal, the site server, and the supplier terminal.

2. The trade matching system of consumer and supplier of claim 1, wherein the transaction procedure is after receiving information about the product, price, delivery options, et cetera, and of which actual payment is carried out using the credit card, or through internet banking, account transfer, et cetera.

3. A trade matching system of consumer and supplier, comprising:
a user terminal (100), which transfers the name, image, and the characteristics of the product to the site server, performs transaction process and receives the transaction results based on the supplier's product information received from the site server;
a site searcher terminal (400), which registers on the site server, receives the information about the product requested by the consumer from the site server, transfers the supplier and product details searched from the supplier's website to the site server when the product search results are identical or similar to the demands of the consumer, and receives the result of the transaction if the product is actually purchased;
a site server (200), which receives and saves the supplier, product and purchasing information from the searcher terminal, sends the above information received to the user terminal to aid the consumer's purchasing decision, processes the transaction based on the supplier, product, and purchasing information provided, and sends the results to the user, searcher, and supplier terminal;
a supplier terminal (300), which transmits the supplier, product and purchasing information to the searcher terminal if requested, and receives the results of the transaction if purchasing process is complete; and
an internet or the wireless network (350), which connects the user terminal, the site server, the searcher terminal, and the supplier terminal.

4. The trade matching system of consumer and supplier of claim 3, wherein the transaction procedure is after receiving information about the product, price, delivery options, et cetera, and of which actual payment is carried out using the credit card, or through internet banking, account transfer, et cetera.

5. A trade matching method of consumer and supplier, comprising:
a consumer registering the user terminal on the site server and sending the image, name, and other information about the product they want to purchase to the site server (S11);
a site server displaying the product information on the display unit (S12);
suppliers registering their supplier terminal on the site server, logging into the site server using the terminal and receiving the product information;
comparison of the data of the product the consumer is likely to purchase and the data of the product stored in the supplier terminal (S14);
the supplier's product information being sent to the site server if the products are either identical or similar (S15);
the site server transferring the supplier's product information to the user terminal (S16);
purchasing of the product using the user terminal, by accessing the site server and going through the necessary purchasing process (S17); and
the site server transmitting the transaction results to the user and supplier terminal afterwards, if requested (S18).

6. The trade matching method of consumer and supplier of claim 5, wherein the stage S14 has characteristics of being able to suggest different products, or end the process, or allow another supplier to participate from the stage S13 if matching product cannot be found on the stage S14.

7. A trade matching method of consumer and supplier, comprising:
suppliers registering on the site server using the supplier terminal, and uploading information about the suppliers themselves, the products to be offered, and et cetera on the site server's product database, which is divided into various categories (S21);
consumers registering their user terminal on the site server and sending information like the name, image, and characteristics of the product they would like to purchase to the site server (S22);
a site server receiving the transmitted data and comparing them to the product information stored in the product database, determining whether they are similar or identical (S23);
the site server sending the product information to the user terminal if the products are determined to be similar or identical (S24);
the consumer connecting to the site server and going through the transaction process based on the product, supplier, and purchase information provided (S25); and
information of the completed transaction procedure being sent to the user and the supplier terminal (S26).

8. The trade matching method of consumer and supplier of claim 7, wherein the stage S23 is done by basing on the product's name, image information, product specifications, et cetera.

9. A trade matching method of consumer and supplier, comprising:
consumer and supplier registering their terminal respectively on the site server (S31);
a user terminal sending the name, image, specification and other necessary information of the product in demand to the site server (S32);
a site server displaying the information about the product on the display unit (S33);
a searcher sending the product and purchase information to the site server, if the search of the supplier's websites, et cetera for the product requested by the consumer produces a match (S34);
the site server transmitting the information received to the user terminal (S35);
a transaction process taking place on the site server based on the information sent to the user terminal (S36); and
the site server sending the transaction results to the user, supplier, and the searcher terminal respectively if the order is complete (S37).

10. The trade matching method of consumer and supplier of claim 9, wherein the transaction procedure is after receiving information about the product, price, delivery options, et cetera, and of which actual payment is carried out using the credit card, or through internet banking, account transfer, et cetera.

11. The trade matching method of consumer and supplier of claim 9, wherein the trade matching method of consumer and supplier has the feature of being able to start over at the stage S34 when actual purchase does not occur at the stage S36.
